(19) United States
(12) Patent Application Publication
(10) Pub. No.: US 2011/0012848 A1
(43) Pub. Date: Jan. 20, 2011

(54) Methods and apparatus for operating a multi-object touch handheld device with touch sensitive display

(75) Inventors: Dong Li, Lexington, KY (US); Jin Guo, Cupertino, CA (US)

Correspondence Address: DONG LI, 1605 Kensington Way, LEXINGTON, KY, 40513, US

(73) Assignees: Dong li, Lexington, KY (US); Jin Guo, Cupertino, CA (US)

(21) Appl. No.: 12/736,296

(22) PCT Filed: Apr. 3, 2008
(86) PCT No.: PCT/CN2008/070676

§ 371 Date: Sep. 28, 2010

(51) Int. Cl. G06F 3/041

(52) U.S. Cl. 345/173

(57) ABSTRACT

A method of performing touch operation on a graphical object on a touch sensitive display of a multi-object touch handheld device is provided. The method comprises detecting the presence of at least two touch input objects; determining one of the touch input objects as pointing at a center of operation; determining a type of operation; and performing the type of operation on the graphical object at the center of operation. A handheld device with at least one processor and at least one type of memory is also provided. The handheld device further comprises touch sensitive display capable of showing at least one graphical object and sensing at least two touch input objects; means for determining the presence of the touch input objects touching the touch sensitive display; and means for determining a center of operation.

### FIELD OF THE INVENTION

The present invention relates to the field of man-machine interaction (MMI) of handheld devices, and in particular to the operation of handheld devices with a touch sensitive display capable of sensing multi-object touch.

### BACKGROUND OF THE INVENTION

Apple's Newton and Palm's Pilot developed in the 1990's had made touch sensitive display popular in handheld devices. These first generation touch sensitive display is designed to sense one and only one touch input object and modeled after pen-and-paper metaphor suitable for writing and point-n-click operations but almost unusable for richer operations such as zooming, rotation, and cut-n-paste.

Apple's iPhone developed in the 2000's had made desirable for touch sensitive display capable of sensing multi-object touch. While long and widely known to the HCI (Human-Computer Interaction) community, multi-object touch, and in particular multi-finger touch, for the first time became approachable to the mass with Apple's implementation of a pinch operation for image zooming in the highly publicized iPhone.

Unfortunately, the multi-finger touch operation in iPhone has some notable drawbacks. Firstly, there is no user sensible concept of center of operation in Apple's design. Hence, when zooming out an image, a user almost always has to pinch-then-pan to zoom and then to re-orient the image. For example, when trying to enlarge the face of a person in a picture, we pinch with two fingers. But we soon find that the face of the people in the picture is moving towards the edge and sliding out of display while enlarging with pinching. We have to stop pinching but go panning the picture to have the face of the people back to the center of display. We then resume the pinch operation and experience the sliding effect again. This is fairly annoying and unproductive.

Secondly, without user sensible center of operation, it is difficult to effectively execute more complex 2-D touch operations such as rotation and 3-D touch operations such as titling. Instead of having the origin for rotation arbitrary located at an obscure position such as the middle of two touch fingers, it is desirable to have it at a fingertip under user's direct and explicit control.

Hence there is a need to develop more user friendly methods and apparatus for operating multi-object touch handheld devices with touch sensitive display.

### SUMMARY OF THE INVENTION

The present invention discloses a method, an apparatus, and a computer program for operating a multi-object touch handheld device with touch sensitive display based on center of operation. The present invention improves the usability of previously complex 2-D touch operations and enhances the functionality of previously sparse 3-D touch operations with multi-object touch on touch sensitive display.

The present invention teaches a method of performing touch operation on a graphical object on a touch sensitive display of a multi-object touch handheld device. This comprises detecting the presence of at least two touch input objects; determining one of the said touch input objects as pointing at a center of operation; determining a type of operation; and performing the said type of operation on the said graphical object at the said center of operation.

At least one of the said touch input objects may be a human finger.

The said center of operation may be a point of interest.

The said center of operation may be determined at least partially by area of touch of the said touch input objects.

The said center of operation may be determined at least partially by motion of touch of the said touch input objects. The said motion of touch may be at least partially derived from measuring velocity of the said touch input object. The said motion of touch may also be at least partially derived from measuring acceleration of the said touch input object.

The said center of operation may be determined at least partially by order of touch of the said touch input objects. The said order of touch may be at least partially derived from measuring time of touch of the said touch input objects. The measure of order of touch may also be at least partially derived from measuring proximity of the said touch input objects.

The said center of operation may be determined at least partially by position of touch of the said touch input objects.

The said center of operation may be determined at least partially by number of touch of the said touch input objects.

The said type of operation may be determined at least partially by computing type of physical actions of the said touch input objects.

The said type of physical action may be tapping by at least one of the said touch input objects touching and immediately leaving the said touch sensitive display without notable lateral movement.

The said type of physical action may be ticking by at least one of the said touch input objects touching and immediately leaving the said touch sensitive display with notable movement towards a direction.

The said type of physical action may be flicking by at least one of the said touch input objects touching and moving on the said touch sensitive display for notable time duration or a notable distance and then swiftly leaving the surface with notable movement towards a direction.

The said type of physical action may be pinching by at least two of the said touch input objects touching the said touch sensitive display and one of the at least two touch input objects moving principally along the direction of it towards or away from another of the at least two touch input objects.

The said type of physical action may be press-holding by at least one of the said touch input objects touching and staying on the said touch sensitive display for a notable amount of time without significant lateral movement.

The said type of physical action may be blocking by at least two of the said touch input objects first touching the said touch sensitive display and then lifting at roughly the same time.

The said type of physical action may be encircling by at least one of the said touch input objects moving encircle around one of the other the said touch input objects.

The method may further comprise determining current application state and retrieving the set of types of operations allowed for the said current application state.

The said type of operation may be zooming, comprising changing the size of at least one graphic object shown on the said touch sensitive display and sticking the said at least one graphic object at the said center of operation.

The said type of operation may be rotation, comprising changing the orientation of at least one graphic object shown on the said touch sensitive display and sticking the said at least one graphic object at the said center of operation.

The said rotation type of operation may be coupled with encircle type of physical action; comprising: at least one of the said touch input objects moving encircle around one of the other the said touch input objects; and the motion of touch is in deceleration before lifting the moving touch input object.

The said rotation type of operation may be coupled with encircle type of physical action; comprising: at least one of the said touch input objects moving encircle around one of the other the said touch input objects; the motion of touch is in acceleration before lifting the moving touch input object; and at least one graphical object orientation is turned by 90 degree.

The said type of operation may be 3D rotation, comprising changing the orientation of at least one graphic object shown on the said touch sensitive display in spatial 3D space and sticking the said at least one graphic object at the said center of operation.

The said 3D rotation type of operation may be coupled with pinch and encircle type of physical action; comprising at least two of the said touch input objects touching the said touch sensitive display and one of the at least two touch input objects moving principally along the direction of it towards or away from another of the at least two touch input objects; at least one of the said touch input objects moving encircle around one of the other the said touch input objects; and the motion of touch is in deceleration before lifting.

The said 3D rotation type of operation may be coupled with pinch and encircle type of physical action; comprising: at least two of the said touch input objects touching the said touch sensitive display and one of the at least two touch input objects moving principally along the direction of it towards or away from another of the at least two touch input objects; at least one of the said touch input objects moving encircle around one of the other the said touch input objects; the motion of touch is in acceleration before lifting; and at least one graphical object orientation is turned by 90 degree.

The present invention also teaches a handheld device with at least one processor and at least one type of memory, further comprising: touch sensitive display capable of showing at least one graphical object and sensing input from at least two touch input objects; means for determining the presence of the said touch input objects touching the said touch sensitive display; and means for determining a center of operation.

The said touch sensitive display may sense touch input objects by measuring at least one of the following physical characteristics: capacitance, inductance, resistance, acoustic impedance, optics, force, or time.

The said means for determining the said center of operation may comprise at least one of the following means: means for measuring area of touch; means for measuring order of touch; means for measuring motion of touch; means for measuring position of touch; means for measuring time of touch; means for measuring proximity of touch; and means for measuring number of touch.

The handheld device may further comprise at least one of the following means for determining type of operation: means for storing and retrieving the definition of at least one type of operations; and means for comparing said sensing input from said touch input objects with the said definition of at least one type of operations.

The handheld device may further comprise means for recording and retrieving application states.

The handheld device may further comprise means for sticking at least one graphical object at the said center of operation for executing said type of operations.

The handheld device may further comprise means for changing said at least one graphical object on the said touch sensitive display.

The important benefits of the present invention may include but not be limited to providing a method, an apparatus, and a computer program for operating multi-object touch handheld device with touch sensitive display based on center of operation. The present invention improves the usability of previously complex 2-D touch operations and enhances the functionality of previously sparse 3-D touch operations with multi-object touch on touch sensitive display.

### BRIEF DESCRIPTION OF THE DRAWINGS

FIG. 1A and FIG. 1B shows the illustration of a multi-object touch handheld device with touch sensitive display in a preferred embodiment of the invention;

FIG. 2 shows the flowchart of a preferred embodiment of the current invention;

FIG. 3 shows the steps to determine the center of operation by order of touch;

FIG. 4 shows the steps to determine center of operation by area of touch;

FIG. 5 shows the steps to determine center of operation by motion of touch;

FIG. 6 shows the steps to determine center of operation by position of touch;

FIG. 7 shows the flowchart of the routine to determine type of operations in the preferred embodiment of this invention;

FIG. 8 shows the flowchart of the routine to determine application independent type of operations in the preferred embodiment of this invention;

FIG. 9 shows the flowchart of the routine to determine application dependent type of operations in the preferred embodiment of this invention;

FIG. 10 shows the flowchart of picture zooming set up routine in the preferred embodiment of this invention;

FIG. 11 shows the flowchart of picture zooming routine in the preferred embodiment of this invention;

FIG. 12A and FIG. 12B shows the illustration of zooming in with stationary thumb as center of operation;

FIG. 13A and FIG. 13B shows the illustration of zooming in with either both thumb and index finger moving and one as moving center of operation;

FIG. 14A and FIG. 14B shows the illustration of zooming out with stationary thumb as center of operation;

FIG. 15A and FIG. 15B shows the illustration of zooming out with either both thumb and index finger moving and one as moving center of operation;

FIG. 16 shows the illustration of rotation around center of operation;

FIG. 17 shows the illustration of cropping with center of operation;

FIG. 18 shows the flowchart of image rotation routine in the preferred embodiment of this invention;

FIG. 19A-FIG. 19D shows the illustration of 3-D image operations with center of operation.

### DETAILED DESCRIPTION OF THE PREFERRED EMBODIMENTS

Multi-Object Touch Handheld Device with Touch Sensitive Display

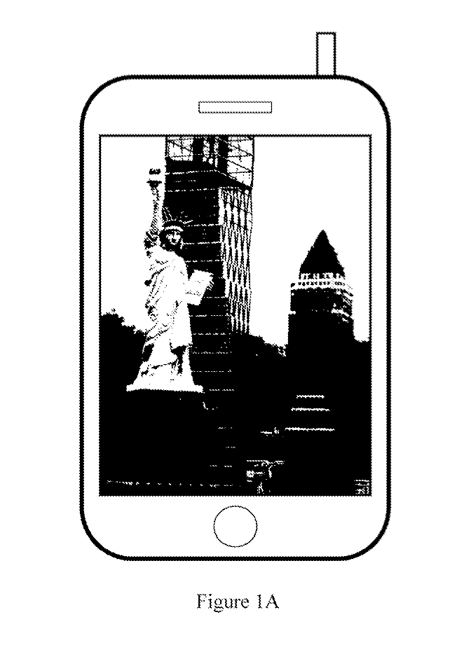

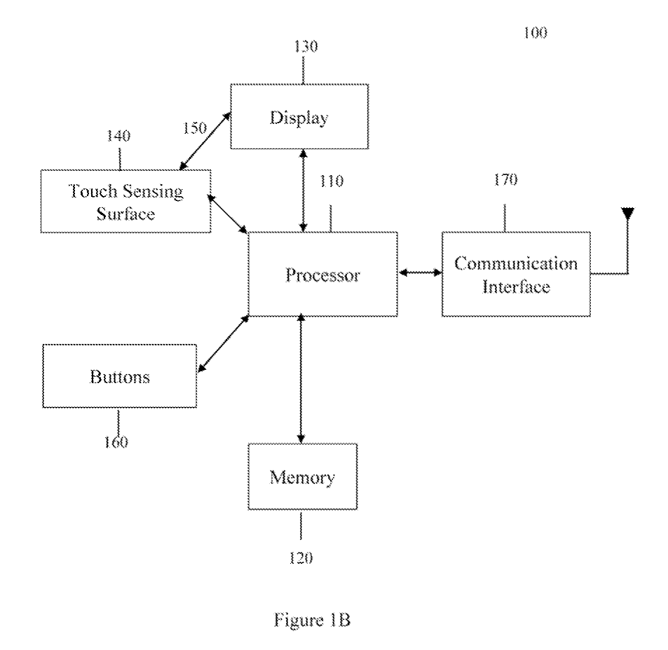

FIG. 1A is an illustration of a multi-object touch handheld device with touch sensitive display and FIG. 1B is its schematic diagram. The handheld device 100 has at least one processor 110, such as CPU or DSP, and at least one type of memory 120, such as SRAM, SDRAM, NAND or NOR FLASH.

The handheld device 100 also has at least one display 130 such as CRT, LCD, or OLED with a display area (not shown) capable of showing at least one graphical object such as raster image, vector graphics, or text.

The handheld device 100 also has at least one touch sensing surface 140 such as resistive, capacitive, inductive, acoustic, optical or radar touch sensing capable of simultaneously sensing touch input from at least two touch input objects (not shown) such as human fingers.

In this invention description, touch may refer to physical contact, or proximity sensing, or both. Touch is well known in the prior art. For example, resistive touch, popular in pen-based devices, works on measuring change in resistance to pressure through physical contact. Capacitive touch, popular in laptop computers, works on measuring change in capacitance to the size and distance of an approaching conductive object. While theoretically capacitive touch does not require physical touch, practically it is usually operated with finger resting on sensing surface. (Surface) acoustic touch, seen in industrial and educational equipments, works on measuring changes in wave forms and/or time to the size and location of an approaching object. Infrared touch, as seen in Smart Board (a type of white board), works on projecting and triangulating infrared or other types of waves to touching object. Optical touch works on taking and processing images of touching object.

While all these are fundamentally different as to their working physical principles, they are all in common as to measuring and reporting touch input parameters such as time of touch and position of touch of one or more physical objects used as input means. The time of touch may be reported only one once or in a series, may be discrete (as in infrared touch) or continuous (as in resistive touch). The position of touch may be a point or area on a flat surface (2-D), curvature or irregular surface (2.5-D), or even a volume in space (3-D). As will become clear later in this invention description, many other types of touch input parameters may be used. Unless otherwise clarified, the current invention does not limit in any way to any touch mechanism and its realization.

Furthermore, the handheld device couples (150) at least part of the touch sensing surface 140 with at least part of the display area of the display 130 to make the latter sensible to touch input. The coupling 150 may be mechanical with the touch sensing surface spatially overlapping with the display area. For example, the touch sensing surface may be transparent and be placed on top of, or in the middle of, the display. The coupling 150 may be electrical with the display itself touch sensitive. For example, each display pixel of the display is both a tiny light bulb and a light sensing unit. Other coupling approaches may be applicable.

In this invention, a display with at least part of the display area coupled with and hence capable of sensing touch input is referred to as touch sensitive display. A handheld device capable of sensing and responding to touch input from multiple touch input objects simultaneously is referred to as multi-object touch capable.

The handheld device may optionally have one or more buttons 160 taking on-off binary input. In this invention description, a button may be a traditional on-off switch, or a push-down button coupled with capacitive touch sensing, or a touch sensing area without mechanically moving parts, or simply a soft key shown on a touch sensitive display, or any other implementation of on-off binary input. Different from general touch input where both time and location are reported, a button input only reports the button ID (key code) and status change time. If a button is on touch sensitive display, it is also referred to as an icon.

The handheld device may optionally have a communication interface 170 for connection with other equipments such as handheld devices, personal computers, workstations, or servers. The communication interface may be a wired connection such as USB or UART. The communication interface may also be a wireless connection such as Wi-Fi, Wi-MAX, CDMA, GSM, EDGE, W-CDMA, TD-SCDMA, CDMA2000, EV-DO, HSPA, LTE, or Bluetooth.

The handheld device 100 may function as a mobile phone, portable music player (MP3), portable media player (PMP), global location service device, game device, remote control, personal digital assistant (PDA), handheld TV, or pocket computer and the like.

### Overview of Preferred Embodiments

In this invention a “step” used in description generally refers to an operation, either implemented as a set of instructions, also called software program routine, stored in memory and executed by processor (known as software implementation), or implemented as a task-specific combinatorial or time-sequence logic (known as pure hardware implementation), or any kind of a combination with both stored instruction execution and hard-wired logic, such as Field Programmable Gate Array (FPGA).

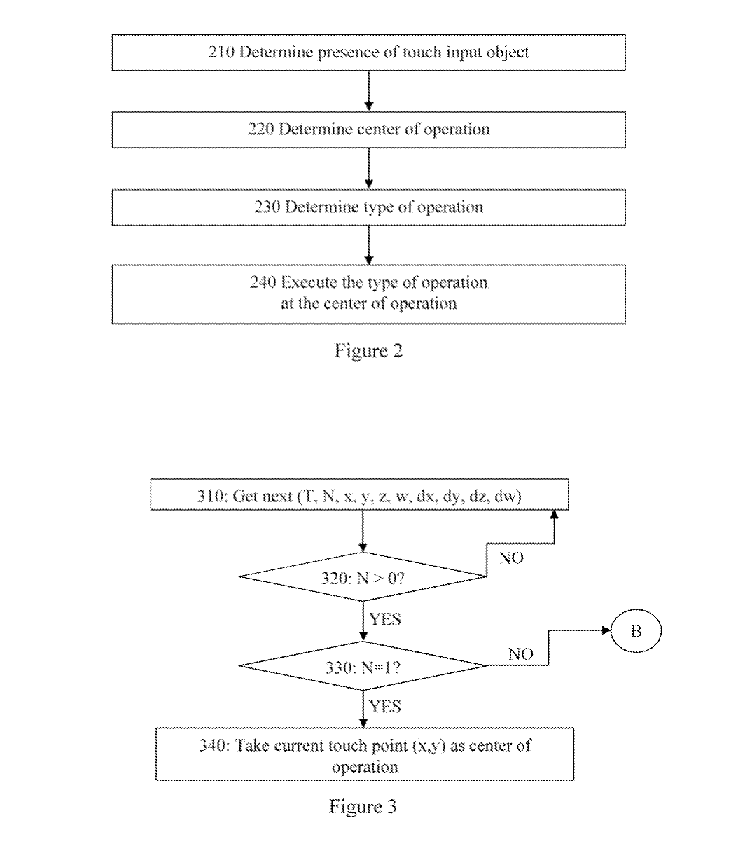

FIG. 2 is the flowchart of a preferred embodiment of the current invention for performing operation on a graphical object on a touch sensitive display of a multi-object touch handheld device. Either regularly at fixed time interval or irregularly in response to certain events, the following steps are executed in sequence at least once.

The first step 210 determines the presence of at least one touch input object and reports associated set of touch input parameters. The second step 220 takes reported touch input parameters and determines a center of operation. The third step 230 takes the same input reported in step 210 and optionally the center of operation determined in step 220 and determines a type of operation. The last step 240 executes the determined type of operation from step 230 at the center of operation from step 220 with the touch input parameters from step 210. Some time, step 230 may be executed before step 220 when the former does not depend on center of operation.

In a preferred embodiment, step 210 may be conducted at fixed time interval 40 to 80 times per second. The other steps may be executed at the same or different time intervals. For example, step 230 may execute only once per five executions of step 210, or only when step 220 reports change in center of operation. Details will become clear in the following sections.

### Touch Input

Step 210 in FIG. 2 determines the presence of touch input objects and associated touch input parameters. In a preferred embodiment, the set of touch input parameters comprises at least one of the following:

t: time of touch—when the touch presence determination is conducted.

n: number of touch—the number of touch input objects detected.

For each touch input object detected:
(x,y): position of touch—a planar coordinate of the center of a touch input object on the touch sensing surface.
z: depth of touch—the depth or distance of a touch input object to the touch sensing surface.
w: area of touch—a simple score representing an aggregated measurement of the area of a touch input object on the touch sensing surface. It may also be a compound structure revealing regular or irregular area of a touch input object on touch sensing surface. For example, w=(a, b) where a and b are the length and width of a best-fit rectangular.
(dx, dy, dz, dw): motion of touch—the relative movement of a touch input object on the touch sensing surface. dx is the change along x direction, dy along y direction, dz along depth, and dw the change in touch area. Some time more detailed measurement is used.

In a type of capacitive touch sensing, the area of touch is directly proportional to the measured value of capacitance as given in the formula:

C=k A/d

where C is the capacitance, k a constant coefficient, A the area of touch and d the distance between touch input object such as human finger and touch sensing surface such as the capacitive touch sensing net beneath the flat glass fixture of a touch sensitive display. Assuming human finger is always on glass, the distance d becomes a constant and hence the capacitance C is directly proportional to area of touch A.

In a type of optical sensing where each display pixel is associated with a light sensing cell, the area of touch is directly proportional to the number of light sensing cells covered or triggered.

It is well known in the prior art that other touch sensing mechanisms may also be able to report area of touch. It should be understandable to those skilled in the art that potential improvements are not limited in any way to those listed above and none of the improvements may depart from the teachings of the present invention.

The motion of touch may be measured directly from touch sensing signals. In a type of capacitive touch sensing, this may be the rate of change in capacitance. In a type of optical touch sensing, this may be the rate of change in lighting.

The motion of touch may also be derived from change of position of touch or area of touch over time. In a preferred embodiment, the position of touch input may be represented as a time series of points:

(t1, x1, y2, z1, w1), (t2, x2, y2, z2, w2), . . . , (tn, xn, yn, zn, wn), . . .

where tk is time, (xk, yk, zk) is position of touch at time tk, and wk is the area of touch at time tk. Hence at time tk, the velocity along a dimension may be calculated as

dxk=(xk−xk−1)/(tk−tk−1)

dyk=(yk−yk−1)/(tk−tk−1)

dzk=(zk−zk−1)/(tk−tk−1)

dwk=(wk−wk−1)/(tk−tk−1)

And the speed of motion of touch may be:

Sk=SQRT(dxk̂2+dyk\hat{0}2+dzk\hat{0}2+dwk\hat{0}2)

By comparing Sk from one touch input object with the other, we may tell which one is moving faster or slower.

In a preferred implementation, the above may be further improved in at least one of the following ways. Firstly, to reduce computation, absolute difference may be used instead of square root. And by assuming equal duration sampling where tk−tk−1 is a constant, the speed of motion of touch may be measured as:

Sk=|xk−xk−1|+|yk−yk−1|zk−zk−1|

Secondly, a smoothing filter may be added to process time series data before speed calculation. This may reduce impact of noise in data.

Motion of touch may not be limited to speed. Other types of measurements, such as acceleration and direction of motion, may also be employed either in isolation or in combination. For a type of touch sensing where z or w is not available, a constant value may be reported instead.

### Center of Operation by Order of Touch

FIG. 3 shows the steps of a preferred embodiment to determine center of operation by order of touch. This may be part of step 220.

In step 310, the results from step 210 are received. Step 320 first checks if there is at least one touch input object presence. If not, the process goes back to step 310 to receive the next touch input. If there is at least one touch input object detected, the process proceeds to step 330 to check if there is one and only one touch input object. If yes, the process proceeds to step 340. If not, it is not reliable to determine center of operation by order of touch alone. The process proceeds to point B.

In a preferred embodiment, step 340 is reached when there detected one and only one touch input object. This step conducts some needed verification and bookkeeping work and declares that the touch input object with the first order of touch points to the center of operation at its position of touch.

It should be understandable to those skilled in the art that potential improvements are not limited in any way to what above and none of the improvements may depart from the teachings of the present invention. For example, to improve the reliability of the determination of center of operation by order of touch, the first few (such as 3 or 5) touch input points may be taken and final decision is made by majority voting (such as 2 out of 3 or 3 out of 5). This is one of the approaches for handling touch de-bouncing.

For touch sensing mechanisms where proximity is measurable, the approaching speed and distance of touch input objects may also be used to determine order of touch. For example, if touch input object A moves faster than touch input object B towards touch sensing surface, even if finally B lands on touch sensing surface shortly ahead of A, it is still more reliable to judge A as intended first landing touch input object because of its approaching speed.

### Center of Operation by Area of Touch

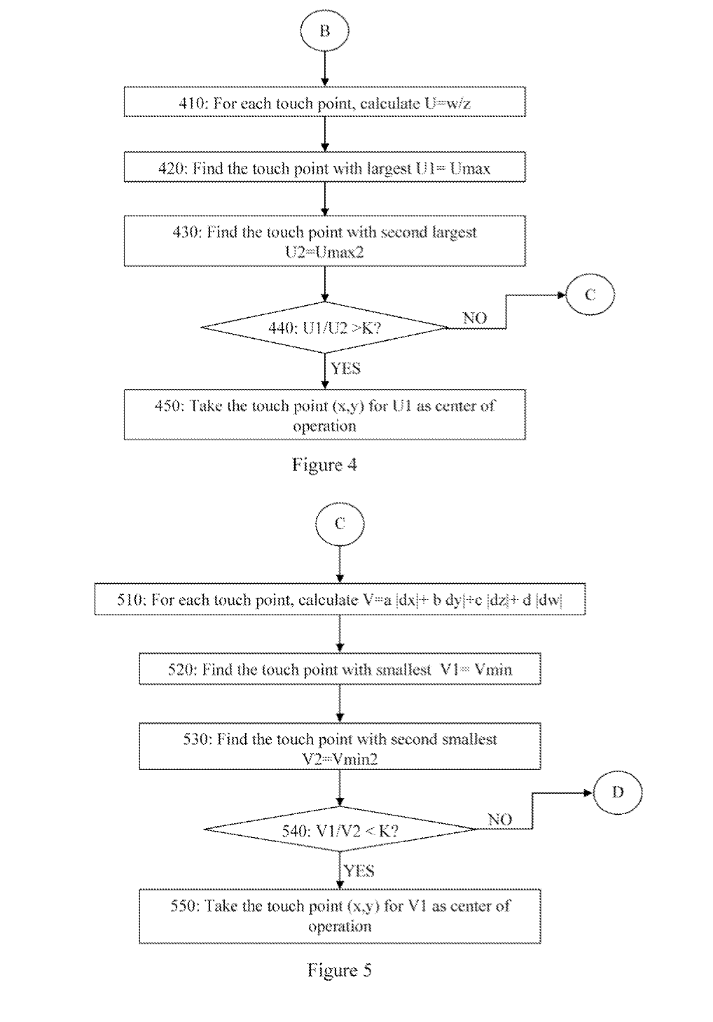

FIG. 4 shows the steps of a preferred embodiment to determine center of operation by area of touch. This may be part of step 220.

In a preferred embodiment, it starts from point B in FIG. 3 when the first approach of determining center of operation by order of touch is not reliable on its own. The process may also be applied independently where the entry point may be after step 210 in FIG. 2. It may also be used together with other approaches in different sequences of application and combination.

In a preferred embodiment, step 410 calculates area-to-distance ratio U as aggregated measure of area of touch. This measure may be proportional to area of touch w and inversely proportional to depth of touch z. That is,

U=w/z.

The actual measurement shall be further adjusted to different sensing mechanisms. In particular, a floor distance shall be set to avoid z being zero.

Step 420 finds the touch input object with the largest U1. And step 430 finds the touch input object with the second largest U2. Step 440 checks if there is significant difference between the largest U1 and the second largest U2. If the difference is significant as it exceeds a pre-set threshold K, the process proceeds to step 450 and declares that the touch input object with the largest area of touch points to the center of operation at its position of touch. Otherwise, the process proceeds to step C.

It should be understandable to those skilled in the art that potential improvements are not limited in any way to what above and none of the improvements may depart from the teachings of the present invention. For example, to improve reliability, the measure of U may be accumulated and averaged during a short period of time, such as 3 or 5 samples.

The center of operation may also be chosen as the position of touch of a touch input object with the least U instead of the largest U.

The area of touch may also be measured in different ways, such as using w only (U=w) or z only (U=1/z), or in different formulae, such as U=aw−bz where a and b are pre-chosen constants.

### Center of Operation by Motion of Touch

FIG. 5 shows the steps of a preferred embodiment to determine center of operation by motion of touch. This may be part of step 220.

In a preferred embodiment, it starts from point C in FIG. 4 when the first approach of determining center of operation by order of touch and the second approach of determining center of operation by area of touch both are not sufficiently reliable. The process may also be applied independently where the entry point may be after step 210 in FIG. 2. It may also be used together with other approaches in different sequences of application and combination.

In a preferred embodiment, step 510 calculates a weighted sum of component motion of touch as the aggregated measure of motion of touch. It may be proportional to the absolute motion of each component motion of touch and weighted properly to reflect the relative importance and dynamic range of value of each component. That is,

V=a|dx|+b dy|+c|dz|+d|dw|

where (a, b, c, d) are coefficients.

The actual measurement shall be further adjusted to different sensing mechanisms. For example, |dx| and |dy| may have higher weightings than |dz| and |dw|.

Step 520 finds the touch input object with the smallest V1. And step 530 finds the touch input object with the second smallest V2. Step 540 checks if there is a significant difference between the smallest V1 and the second smallest V2. If the difference is significant as it exceeds a pre-set threshold K, the proceeds to step 550 and declares that the touch input object with the smallest motion of touch points to the center of operation at its position of touch. Otherwise, it proceeds to step D for further processing.

It should be understandable to those skilled in the art that potential improvements are not limited in any way to what above and none of the improvements may depart from the teachings of the present invention. For example, to improve reliability, the measure of V may be accumulated and averaged during a short period of time, such as 3 or 5 samples.

The center of operation may also be chosen as the position of touch of a touch input object with the largest V instead of the least V.

The motion of touch may also be measured in different ways, such as using dx only (V=|dx|), or y only (V=|dy|), or in different formulae, such as U=a |dx dy|+b |dw dz| where a and b are coefficients. The speed of motion of touch Sk=SQRT (dxk\hat{0}2+dyk\hat{0}2+dzk\hat{0}2+dwk\hat{0}2) may also be applied in a similar fashion. And a low pass filter may be applied to above calculated data.

### Center of Operation by Position of Touch

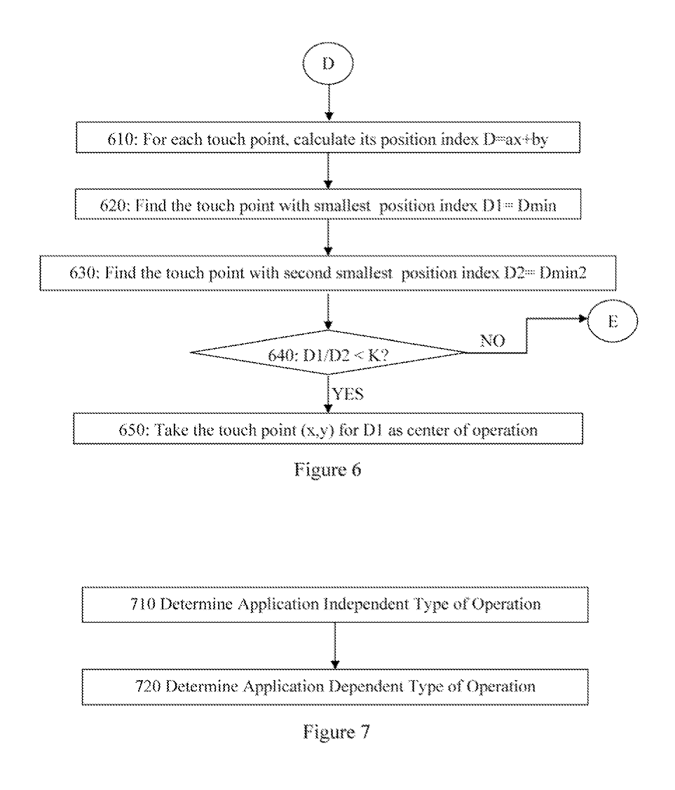

FIG. 6 shows the steps of a preferred embodiment to determine center of operation by position of touch. This may be part of step 220.

In a preferred embodiment, it starts from point D in FIG. 5 when the first approach of determining center of operation by order of touch, the second approach of determining center of operation by area of touch, and the third approach of determining center of operation by motion of touch are not sufficiently reliable. The process may also be applied independently where the entry point may be after step 210 in FIG. 2. It may also be used together with other approaches in different sequences of application and combination.

In a preferred embodiment, step 610 calculates a weighted sum of component position of touch as aggregated measure of position of touch (position index). The measure may be proportional to the position of each component position of touch and weighted properly to reflect the relative importance and dynamic range of value of each component. That is,

D=ax+by

where a and b are coefficients.

The actual measurement may be further adjusted to different sensing mechanisms.

Step 620 finds the touch input object with the smallest position index D1. And step 630 finds the touch input object with the second smallest position index D2. Step 640 checks if there is significant difference between the smallest D1 and the second smallest D2. If the difference is significant as it exceeds a pre-set threshold K, the process proceeds to step 650 and declares that the touch input object with the smallest position of touch index points to the center of operation at its position of touch. Otherwise, the process proceeds to step E for further processing.

Step E may be any other approach in line with the principles taught in this invention. Step E may also simply return a default value, such as always choosing the touch input object with the lower most or leftmost position of touch as what pointing to the center of operation.

It should be understandable to those skilled in the art that potential improvements are not limited in any way to those listed above and none of the improvements may depart from the teachings of the present invention. For example, to improve reliability, the measure of D may be accumulated and averaged during a short period of time, such as 3 or 5 samples.

The above taught four approaches, and other approaches in line with current teaching, may be applied in any sequence and combination. Furthermore, if one touch input object is determined as pointing to center of operation at position of touch, it may be kept as is until absolutely necessary to switch. This helps to avoid potential jumping effect (center of operation frequently changes among multiple touch input objects).

### Determine Type of Operations

Referring back to FIG. 2, after determining center of operation in step 220, the next step 230 determines type of operation. At given center of operation, usually there are multiple types of operations valid to be executed. For example, in a typical image browsing application, possible operations include picture panning, zooming, rotating, cropping and titling. FIG. 7 shows how step 230 may be implemented first in step 710 and then in step 720.

Step 710 is to determine application independent type of operations, also called syntactic type of operations, with focus on the type of physical actions a user applies, such as tapping and double tapping. Step 720 is to determine application dependent type of operations, also called semantic type of operations, with focus on the type of goals a user aims at, such as picture zooming and panning.

### Determine Application Independent Type of Operation

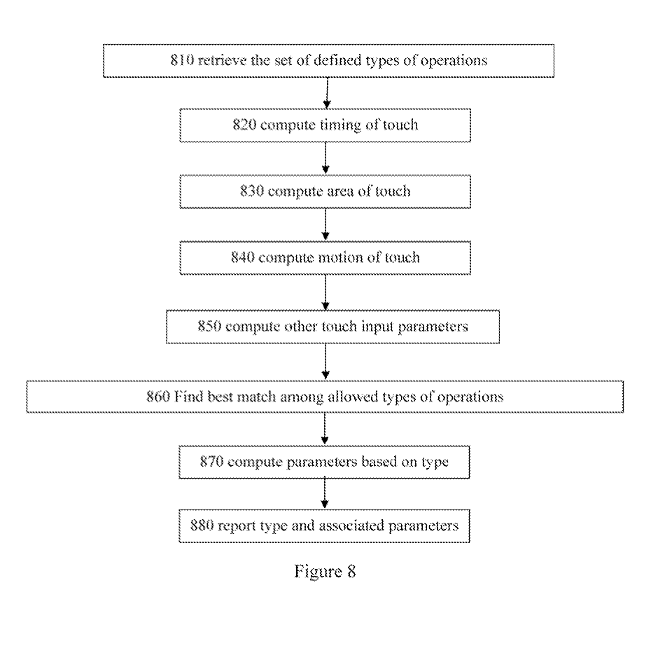

FIG. 8 shows the detail flowchart of step 710 in a preferred embodiment of this invention. The first step 810 is to retrieve the set of allowed application independent types of operations. Table 1 exemplifies such a set for operations carried by only one touch input object. Well known examples include tap, double-tap, tick and flick. To simplify follow-up processing, type invalid may be added to capture all ill-formed cases.

TABLE 1
Samples of application independent types of operations.

| | Motion | | | |
|---|---|---|---|---|
| Touch | Speed | 1 time | 2 times | Notes |
| Point | Fast | Tap | Double tap | Put finger down and then immediately lift |
| | | | | up without lateral movement |
| Point | Slow | Press-Hold | | |
| Short Line | Fast | Tick | | Put finger down and then immediately lift |
| | | | | to a direction with a short swipe |
| Short Line | Slow | Drag | | |
| Long Line | Fast | Flick | | Put finger down and then move to a |
| | | | | direction in high speed for a notable |
| | | | | distance then quickly lift up |
| Long Line | Slow | Stroke | | |
| Area | Fast | Paddle | Clap | Put whole thumb (or a portion with |
| | | | | significant size of area) down then |
| | | | | immediately life up. |
| Area | Slow | Cover | | |
| Mixed | Mixed | Gestures | Gestures | |
| Mixed | Mixed | Invalid | invalid | |

In a preferred embodiment of the invention, application independent types of operations may be defined by at least one of the following touch factors: number of touch, timing of touch, order of touch, area of touch, motion of touch, and position of touch. These together may form various types of physical actions.

For example, tapping is a type of physical action defined as at least one touch input object touching and immediately leaving the touch sensitive display without notable lateral movement.

Ticking is another type of physical action defined as at least one touch input object touching and immediately leaving the said touch sensitive display with notable movement towards a direction.

Flicking is yet another type of physical action defined as at least one touch input object touching and moving on the said touch sensitive display for a notable time duration or a notable distance and then swiftly leaving the surface with notable movement towards a direction.

Pinching type of physical action is defined as at least two touch input objects touching the said touch sensitive display and one of the at least two touch input objects moving principally along the direction of it towards or away from another of the at least two touch input objects.

Press-holding type of physical action is defined as at least one touch input object touching and staying on the touch sensitive display for a notable amount of time without significant lateral movement.

Blocking type of physical action is defined as at least two touch input objects first touching the said touch sensitive display and then lifting at roughly the same time.

Encircling type of physical action is defined as at least one touch input object moving encircle around one of the other the said touch input objects.

Each application independent type of operations may always be associated with a set of operation parameters and their valid dynamic ranges, together with an optional set of validity checking rules.

For example, tap, as an application independent type of operation, may be defined as a single touch input object (number of touch) on touch sensitive surface for a notably short period of time of touch without significant motion of touch and area of touch. In one implementation, the set of validity checking rules may be:

number of touch: N=1

area of touch: 5 pixels<W<15 pixels

time of touch: 20 ms<T<100 ms

motion of touch: 0<=M<=5 pixels

Furthermore, tap, as an application independent type of operation, may have position of touch (x,y) and time of touch t as associated operation parameters.

Another example, pinch, also as an application independent type of operation, may be defined as two touch input objects on touch sensitive surface with at least one touch input object moving eccentric towards or away from the other touch input object along a relatively stable (i.e., not too fast) motion of touch. A similar set of operational parameters and set of validity checking rules may be chosen.

Not all touch factors and operation parameters are required for all types of operations. For example, when defining tap operation, area of touch may only be a secondary touch factor and be ignored in an implementation.

In FIG. 8, together with retrieving definitions of the set of application independent types of operations, a set of touch factors is evaluated and corresponding sets of touch input parameters are calculated in step 820 to 850, for time, area, motion and other aspects of touch, as taught above.

Step 860 is to find the best match of actual touch action with the set of definitions. In this step, the primary work is to check type definitions against various touch factors of current touch operation. For example, after knowing number of touch N in step 850, step 860 may check it against the set of validity checking rules for the tap operation. If N is not 1, the current operation of touch cannot be tap. If N=1, tap becomes a tentative candidate of matching type of operation. Another example, after knowing time of touch T at step 820, step 860 may further check if it is within the valid dynamic range for tap type of operation. Further, a matching score may be calculated against long stay. Defining the score as S=T, a smaller score indicates a better match.

The actual order of processing from step 820 to 860 may be implementation dependent for performance reasons. For example, instead of sequential processing from step 820 to step 860, a decision tree approach well known to those skilled in the art may be employed to first check the most informative touch factor and to use it to rule out a significant number of non-matching types of operations, then to proceed to the next most information touch factor as determined by the remaining set of candidate types of operations.

Optionally, each type of operation may be associated a pre-defined order of priority, which may be used to determine the best match when there are more than one type of operations matching current user action.

It should be understandable to those skilled in the art that potential improvements are not limited in any way to those listed above and none of the improvements may depart from the teachings of the present invention. For example, not all steps between step 820 and step 860 are all mandatory for all application independent types of operations.

After the best application independent type of operation is determined at step 860, its associated set of operation parameters may be calculated in step 870 and reported in step 880.

### Determine Application Dependent Type of Operation

Referring back to FIG. 7. After determining application independent type of operations and associated set of operation parameters, the follow up step 720 determines application dependent type of operations, also called semantic type of operations, with focus on the type of goals a user aims at, such as picture zooming and panning.

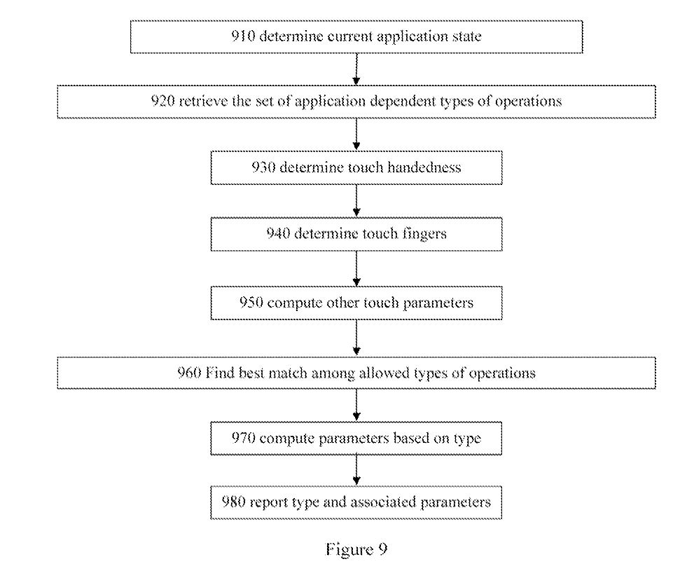

FIG. 9 shows the detail flowchart of step 720 in a preferred embodiment of this invention. With knowing application independent type of operations, the first step 910 is to retrieve current application state, defined by the set of allowed application dependent type of operations and registered with operating system in which applications run. Example application states include Picture browsing and web browsing. In a preferred embodiment of the invention, application states are organized into a table, as in Table 2.

TABLE 2
Table of Application States

| | | Associated Table of Application |
|---|---|---|
| State ID | State Name | Dependent Types of Operations |
| 1 | PictureBrowsing | Table 3 |
| 2 | WebBrowsing | . . . |
| . . . | . . . | . . . |

For each state, a set of supported application dependent types of operations is listed. These application dependent types of operations are defined by at least one of the following aspects: application independent type of operation, handedness (left-handed, right-handed, or neutral), and characteristics of touch input objects (thumb, index finger, or pen). Table 3 below exemplifies one set of application dependent types of operations for picture browsing application state.

TABLE 3
Table of Application Dependent Types of Operations

| | | | | Finger not |
|---|---|---|---|---|
| Application | Application | | Finger pointing | pointing at |
| Dependent Type | Independent Type | | at Center of | Center of |
| of operation | of operation | Handedness | operation | operation |
| Zooming | Pinch | Right | Thumb | Index |
| Zooming | Pinch | Left | Thumb | Middle |
| Titling | Dual-Finger | Right | Index | Middle |
| | Press-Hold | | | |
| . . . | . . . | . . . | . . . | . . . |

In this example, picture zooming, as an application dependent type of operation, is defined by pinch, which is an application independent type of operation, in right-handed mode with thumb and index finger, and in left-handed mode with thumb and middle finger, where thumb is used as center of operation in both modes. The actual sets of definitions are application specific and are designed for usability.

It should be understandable to those skilled in the art that potential implementations are not limited in any way to those listed above and none of the implementations may depart from the teachings of the present invention. For example, data structures such as lists, trees, and graphs, or databases, may be used in place of the above tables.

When using thumb and index finger as touch input objects, the thumb may always touch a lower position of a touch sensitive surface than where the index finger touches. Furthermore, to people with right-handedness, the thumb position of touch may always be to the left side of that of the index finger. For people with left-handedness, the thumb may always be to the right side of that of the index finger. Similar fixed position relationships may exist for other one-hand finger combinations. Such relationship may be formulated as rules and registered with operating system and be changed by user in the user preference settings in order to best fit user preference. When human fingers or equivalents are used as touch input objects, the next step 930 determines handedness—left-handed, right-handed, or neutral. In a preferred embodiment of this invention, this may be implemented by considering at least position of touch. A set of rules may be devised based on stable postures of different one-hand finger combinations for different handedness.

For example, generally in thumb-index dual-finger touch, the index finger is usually at the upper-right side of thumb for right-handed people but at the upper-left side of thumb for left-handed people. Table 4 and Table 5 below list one possibility of all the combinations and may be used in a preferred embodiment of the invention. Both tables may be system predefined, or learned at initial calibration time, or system default be overridden later with user setting.

TABLE 4
Right-Handed Table

| Right-Handed Table | Thumb | Index Finger | Middle Finger | Ring Finger | Little Finger |
|---|---|---|---|---|---|
| Thumb | | Lower left | Lower left | Lower left | Lower left |
| Index Finger | Upper right | | Lower left | Lower left | Lower left |
| Middle Finger | Upper right | Upper right | | Lower left | Lower left |
| Ring Finger | Upper right | Upper right | Upper right | | Lower left |
| Little Finger | Upper right | Upper right | Upper right | Upper right | |

TABLE 5
Left-Handed Table

| Left-Handed Table | Thumb | Index Finger | Middle Finger | Ring Finger | Little Finger |
|---|---|---|---|---|---|
| Thumb | | Lower left | Lower left | Lower left | Lower left |
| Index Finger | Upper right | | Lower left | Lower left | Lower left |
| Middle Finger | Upper right | Upper right | | Lower left | Lower left |
| Ring Finger | Upper right | Upper right | Upper right | | Lower left |
| Little Finger | Upper right | Upper right | Upper right | Upper right | |

The next step 940 determines the actual fingers touched, or generally the characteristics of touch input objects. In a preferred embodiment, this may be implemented by considering area of touch and position of touch.

For example, either learnt with a learning mechanism or hard coded in the system, it may be known that touch by thumb may have an area or touch larger than that by index finger. Similarly, the area of touch from a middle finger may be larger than that from an index finger. Because both thumb-to-index and index-to-middle fingers position of touch relationships may both be lower-left to upper-right, by position of touch relationship alone, as registered in Table 4, may not be enough to reliably determine which pair of fingers actually used. However, if the area of touch from the lower left touch input object is larger than that from the upper right touch input object, the one touches at lower left side is likely the thumb, because it has larger area of touch than index finger. Similar inferences for other situations may also be conducted.

Steps 950 to 980 are parallel to steps 850 to 880. While the latter are based on definitions in Table 1, the former are based on definitions in Table 3. The rest are similar.

It should be understandable to those skilled in the art that potential improvements are not limited in any way to those listed above and none of the improvements may depart from the teachings of the present invention. For example, the above tables may be implemented in many different ways. For handheld devices with relational database support, the tables may be easily managed by database. For handheld devices without database support, the tables may be stored as arrays. Not all steps are needed in all applications. The sequential procedure from step 910 to step 980 is for clarity only and may be executed in other orders. Approaches such as decision trees and priority list may also be applicable here.

### Execute Touch Operation at Center of Operation

Referring back to FIG. 2. After determining presence of touch at step 210, determining center of operation at step 220, and determining type of operation at step 230, the next is to carry out step 240—executing the determined application dependent type of operations at determined center of operation with calculated touch input parameters and derived operation parameters.

There may have many different applications and each application may carry out many different types of operations with one or more touch input objects. Without departing from the essence of the invention, the teachings will be exemplified in the following representative cases.

### Picture Zooming

When executing picture zooming, it is reasonable to assume that there is a picture shown in at least part of the display area of the display, referred to as a display window. Furthermore, there exists a pre-defined coordinate system of the display window and another coordinate system for the picture.

For example, the coordinate system of the display window may have origin at the upper-left corner of the display window, horizontal x-axis to the right and vertical y-axis downwards. Similarly, the coordinate system of the picture may have origin at the upper-left corner of the picture and x/y aisles with the same orientation as that of the display window. In addition, we may reasonably assume that both take pixel of the same dimensions as unit of scale.

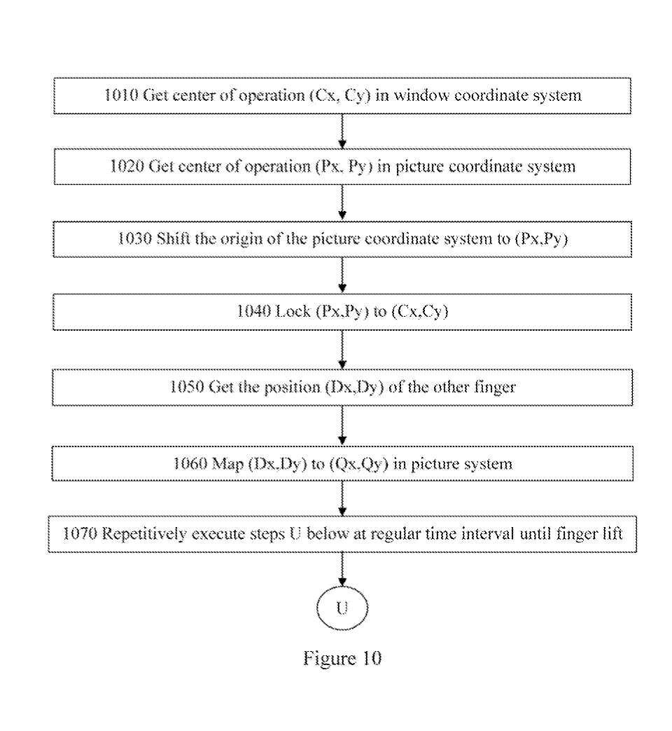

FIG. 10 is the first part of the process of executing touch operation. Step 1010 gets center of operation (Cx, Cy) in the coordinate system of the display window. This may be implemented through a transformation mapping from the coordinate system of the touch sensitive surface to the coordinate system of the display window. A transformation mapping formula may be:

Cx=a1Sx+b1Sy+c1

Cy=a2Sx+b2Sy+c2

where (Sx, Sy) is the center of operation in the coordinate system of the touch sensitive surface, and (a1, b1, c1) and (a2, b2, c2) are system parameters.

Step 1020 maps the center of operation further into picture coordinate system. With knowing picture coordinate system and display window coordinate system, a transformation mapping similar to the above may be performed to produce required result (Px, Py), which is a point in the picture that is coincidently shown at the position of center of operation (Cx, Cy) in the coordinate system of the display window.

Step 1030 shifts the origin of the picture coordinate system to (Px, Py) through a translation mapping:

x′=x−Px,

y′=y−Py.

Step 1040 locks the point (Px, Py) in picture coordinate system with the position of center of operation (Cx, Cy) in the coordinate system of the display window. This is actually to lock the newly shifted origin of the picture coordinate system to the center of operation (Cx, Cy).

When number of touch is more than one, Step 1050 picks one of the other touch input objects and gets its position of touch (Dx, Dy) in the coordinate system of the display window.

Step 1060 maps (Dx, Dy) to (Qx, Qy) in the new picture coordinate system.

After completing the above set-up transformation steps, at regular time interval (such as 20 times per second), step 1070 checks to see if the multiple touch input objects are still in touch with the touch sensing surface, and if yes, executes the steps in FIG. 11.

After elapsing of a short period of time (such as 50 ms), both the touch input object pointing to the center of operation and the other touch input objects not pointing at the center of operation may move a short distance. The center of operation may have moved from (Cx,Cy) to (C′x, C′y), and the other one from (Dx,Dy) to (D′x,D′y), both in terms of the coordinate system of the display window.

Step 1110 gets (C′x,C′y) by collecting touch sensing parameters and conducting a transformation mapping from the coordinate system of touch sensing surface to the coordinate system of the display window.

Step 1120 may be the most notable step in this invention. It updates the image display to ensure that the newly established origin of the picture coordinate system still locks at the moved center of operation (C′x, C′y). That is, the picture may be panned to keep the original picture point still under the touch input object pointing to the center of operation.

Step 1130 may be similar to step 1110 but for the touch input object not pointing to the center of operation.

Step 1140 may be another most notable step in this invention. The objective is to keep the picture element originally pointed by the other touch input object which is not pointing to the center of operation still under that touch input object. That is, when the touch input object moved from (Dx, Dy) to (D′x, D′y), the corresponding picture element at (Qx, Qy) previously shown at (Dx,Dy) shall now be shown at (D′x,D′y). The key is to scale the picture coordinate system.

Denote

dx=(D′x−C′x)−(Dx−Cx)

dy=(D′y−C′y)−(Dy−Cy)

and let

s=SQRT(dx|\hat{0}2+|dy|\hat{0}2)

we have

Q′x=s*Dx/D′x

Q′y=s*Dy/D′y.

where s is the scaling factors in both x and y dimensions. Other approximations are possible, such as always taking the larger of the two

s=max(|dx|, |dy|),

or the smaller of the two,

s=min(|dx|, |dy|).

Step 1140 concludes with scaling the whole picture with one of the above calculated scaling factors. Steps 1150 and 1160 are merely preparation for the next round of operations.

It should be understandable to those skilled in the art that potential improvements are not limited in any way to those listed above and none of the improvements may depart from the teachings of the present invention. Not all steps are absolutely necessary in all cases. The sequential procedure from step 1110 to step 1160 is for clarity only. In actual implementation image panning (shifting) and zooming (scaling) may be combined in a compound transformation. Any potential improvements may not be limited in any way to those listed above and none of the improvements may depart from the teachings of the present invention.

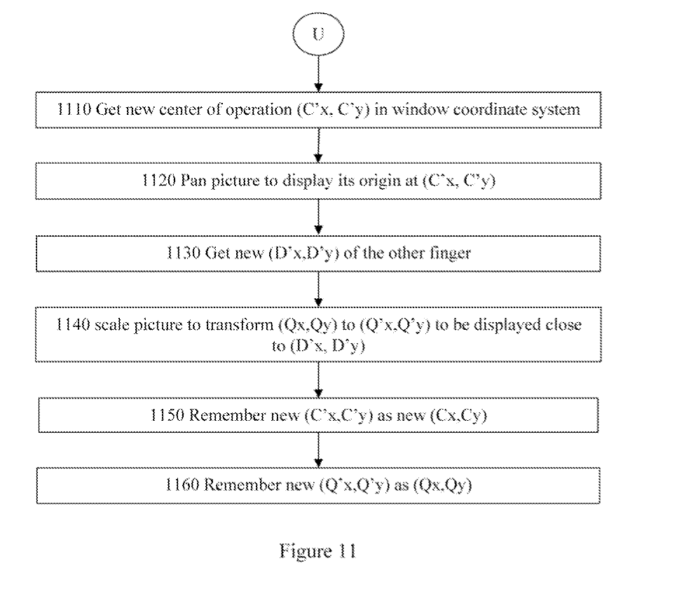

FIG. 12A to FIG. 15B illustrates some of the interesting use cases. FIG. 12A and FIG. 12B show where a user wants to zoom in and enlarge a picture around a point of interest. In FIG. 12A, the user points his or her thumb to the head of the Stature of Liberty as point of interest. The user also points his or her index finger to a nearby position to set basis of operation. FIG. 12B shows his or her finger movements: moving index finger away from thumb to stretch out what between thumb and index finger and enlarge the whole picture proportionally.

With the teaching in this invention, the thumb may point at the center of operation and the distance between thumb and index finger may determine the scaling factor. Furthermore, when the thumb is not moving, the picture element it points at may also be stationary. In FIG. 12A, the head of the Statue of Liberty as point of interest in the picture does not move away from thumb and hence does not go out of screen. Consequently, following the teachings in this invention, the user does not need to pan the image to re-center his point of interests after the zoom-in operation, if user chooses to set the center of operation at his point of interests. This may significantly improve ease of use against Apple's iPhone.

Instead of using thumb, the user may point his index finger to the point of interest and touch his thumb to a nearby point and then move thumb away from index finger to stretch out what between thumb and index finger and enlarge the whole picture proportionally. When index finger is not moving, what it touches is also stationary.

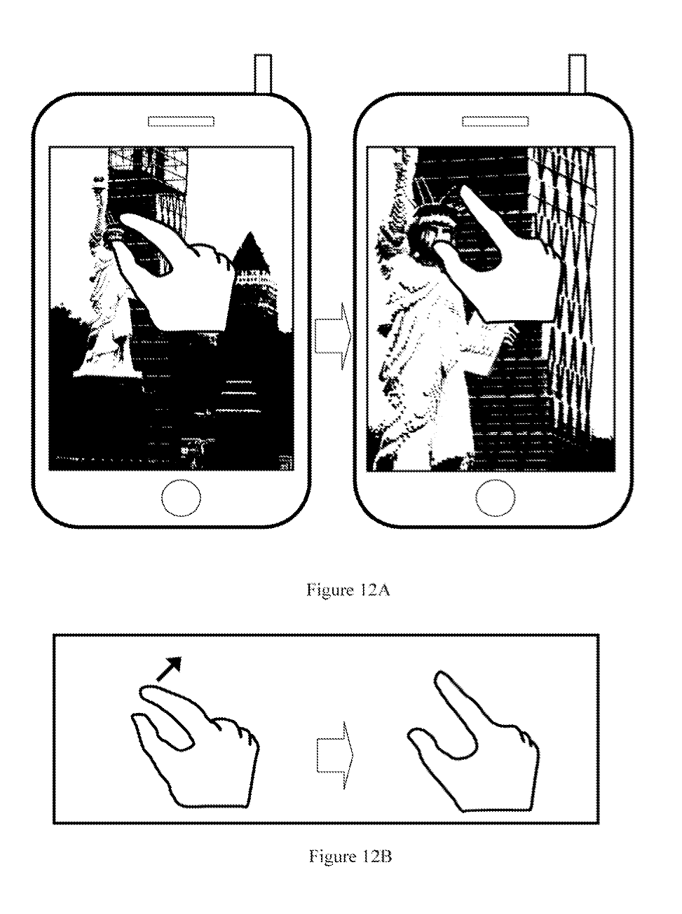

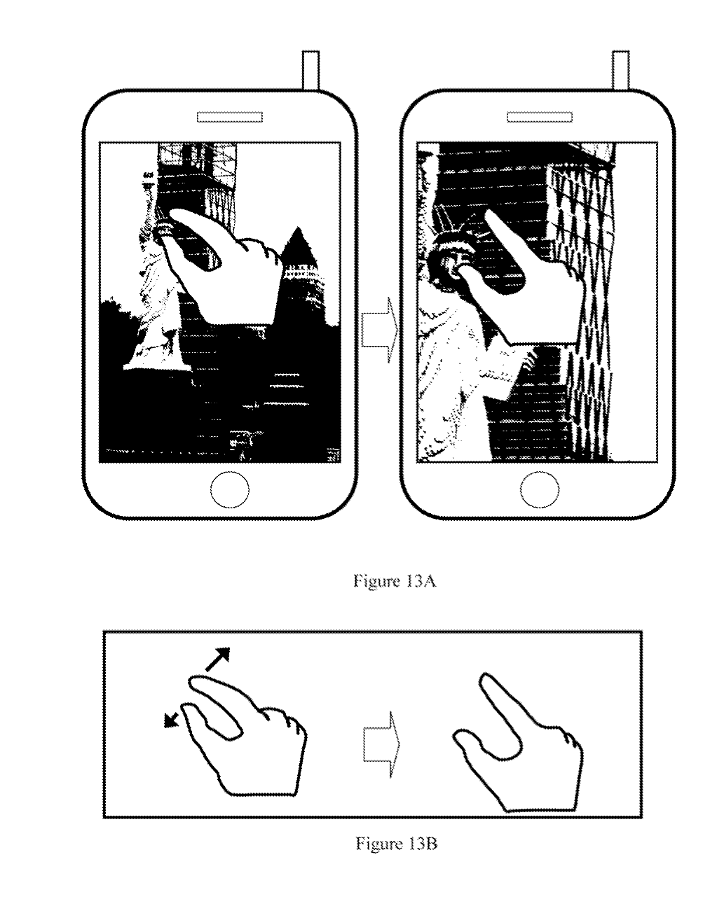

In FIG. 13A, the user may use either index finger or thumb to touch that point of interest and touch the other finger to a nearby point and then move both fingers away from each other to stretch out what between them and enlarge the whole picture proportionally. When both thumb and index finger are moving, the center of operation is also moving accordingly, which in turn pan the whole picture.

FIG. 13B also reveals a significantly difference between the two fingers. Assuming the thumb is what the user chooses to point to his or her point of interests and hence the center of operation, the picture element under thumb touch tightly follows the movement of thumb. That is, the head of the Stature of Liberty is always under the touch of the thumb. In contrast, the picture element initially pointed at by the index finger generally will not be kept under index finger after some movement, especially when picture aspect ratio is to be preserved and computing resource is limited.

When the user lifts both fingers away from touch sensitive display to complete the zooming operation, an optional add-on operation of touch may be to pan the picture and to make the point of interests and hence the center of operation at the center or some other pre-set position of the touch sensitive display. Another optional add-on operation of touch may be to resize the whole picture to at least the size of whole screen. Some other finishing operations may also be added.

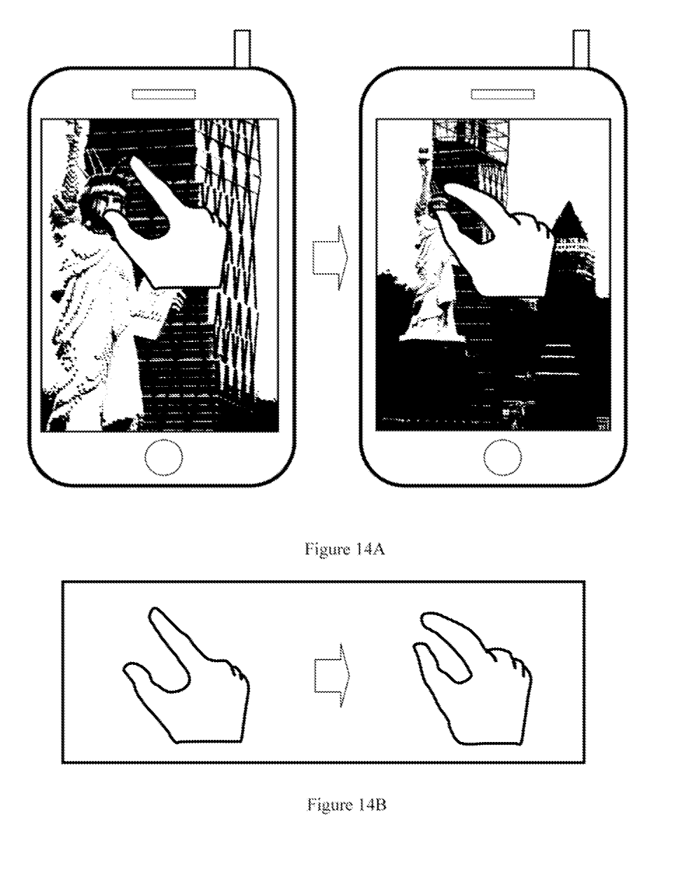

The above teaching of zooming in at center of operation may be applied equally well to zooming out. FIG. 14A and FIG. 14B show a user pointing his thumb to his point of interest and touching his index finger to a nearby point and then moving index finger towards his thumb to squeeze in what between thumb and index finger and reduce the whole picture proportionally. When the thumb is not moving, what it touches is also stationary. Instead of using thumb, the user may point his index finger to his point of interest and touch his thumb to a nearby point and then move thumb towards his index finger to squeeze in what between thumb and index finger and reduce the whole picture proportionally. When the index finger is not moving, what it touches is also stationary.

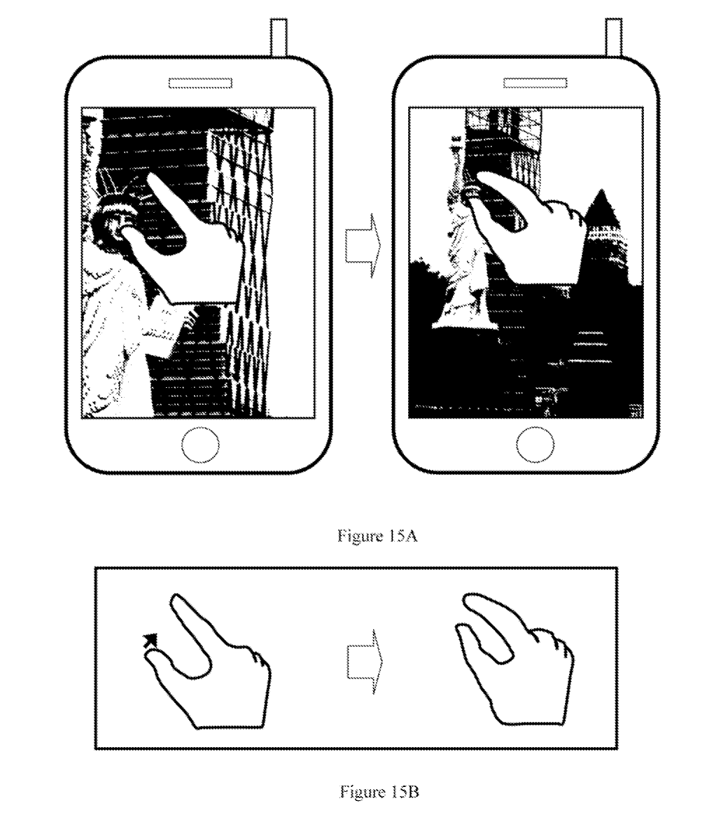

FIG. 15A and FIG. 15B show a user using either index finger or thumb to touch his point of interest and touching the other finger to a nearby point and then moving both fingers towards each other to squeeze in what between them and reduce the whole picture proportionally. When both thumb and index finger are moving, the center of operation is also moving accordingly.

### More Picture 2-D Operations

The picture zooming procedure given in FIG. 10 and FIG. 11 may be adapted to further support other 2-D picture operations such as picture rotation, flipping, and cropping.

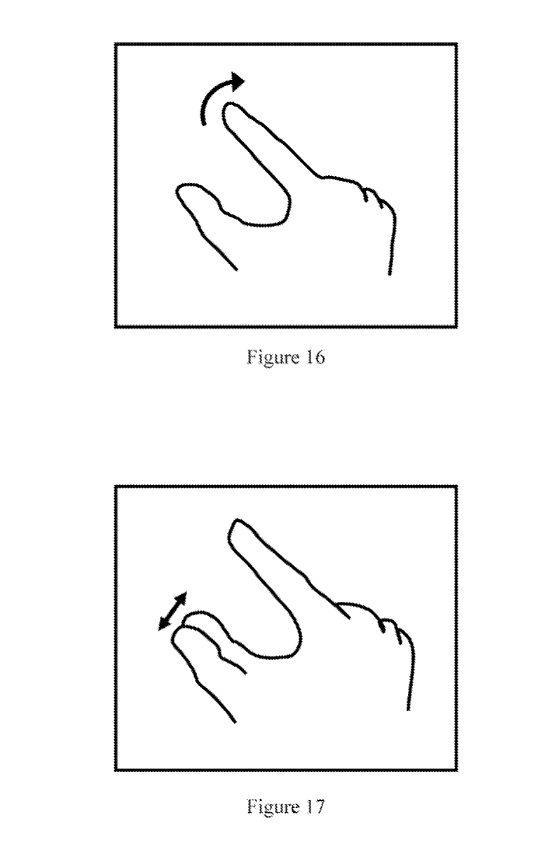

As shown in FIG. 16, a preferred embodiment of rotation operation may be first to select a center of operation with one finger sticking to the point of interests and then to move the other finger encircle around the finger for center of operation. The rotation may be clockwise and counter-clockwise, depending on the direction of finger movement.

There may at least have two distinguishable types of encircle finger movements: drag and swipe. The key difference is: in swipe operation the finger motion is in acceleration when finger leaves touch sensitive surface, while in drag operation the finger motion is in deceleration when finger leaves touch sensitive surface. In this preferred embodiment of rotation operation, drag is used to continuously adjust orientation of image, while swipe is used to rotate image to the next discrete image position, such as 90 degree or 180 degree. Swipe rotation conveniently turns image from portrait view to landscape view and vice versa.

A preferred embodiment of image cropping operation may be first to set center of operation at one of the desired corners of an image to be cropped and then to use another finger to tap on another desired corner of the image, and optionally to move either or both fingers to fine tune the boundaries of the bounding box, and finally to lift both fingers at the same time. FIG. 17 shows the case where the index finger points to center of operation and the thumb taps on screen to define the bounding box of the image.

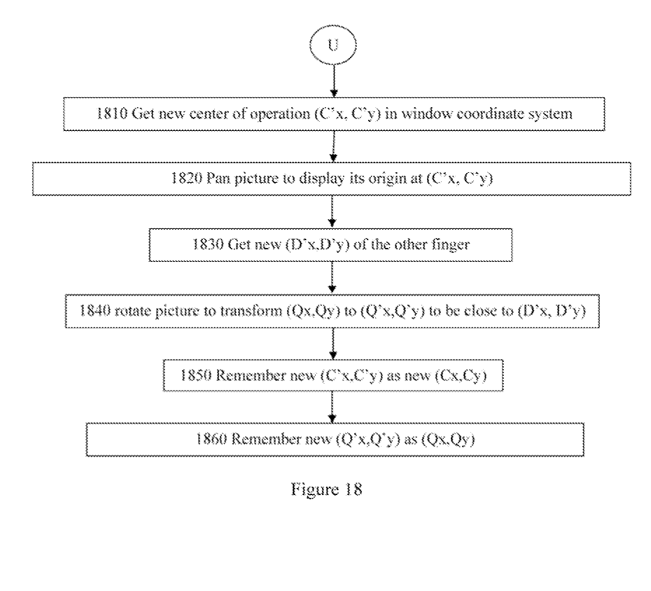

For picture rotation, the same preparation steps described for picture zooming in FIG. 10 may be applicable without change. The differences may be in the subroutine. Instead of using the one in FIG. 11, the image rotation routine is described in FIG. 18. The first three steps 1810 to 1830 and the last two steps 1850 to 1860 are exactly the same as steps 1010 to 1030 and steps 1050 to 1060 in FIG. 10. The only difference is in step 1840. Instead of scaling transformation as in step 1140, here a rotation transformation is called in step 1840.

It should be understandable to those skilled in the art that potential improvements are not limited in any way to those listed above and none of the improvements may depart from the teachings of the present invention. Not all steps are absolutely necessary in all cases. The sequential procedure from step 1810 to 1860 is for clarity only. Practically for better performance the image panning (shifting) and rotation may be performed together in one shot using a compound transformation. Furthermore, picture zooming and picture rotation may also be combined and be executed jointly. Any potential improvements are not limited in any way to those listed above and none of the improvements may depart from the teachings of the present invention.

### 3-D Operations

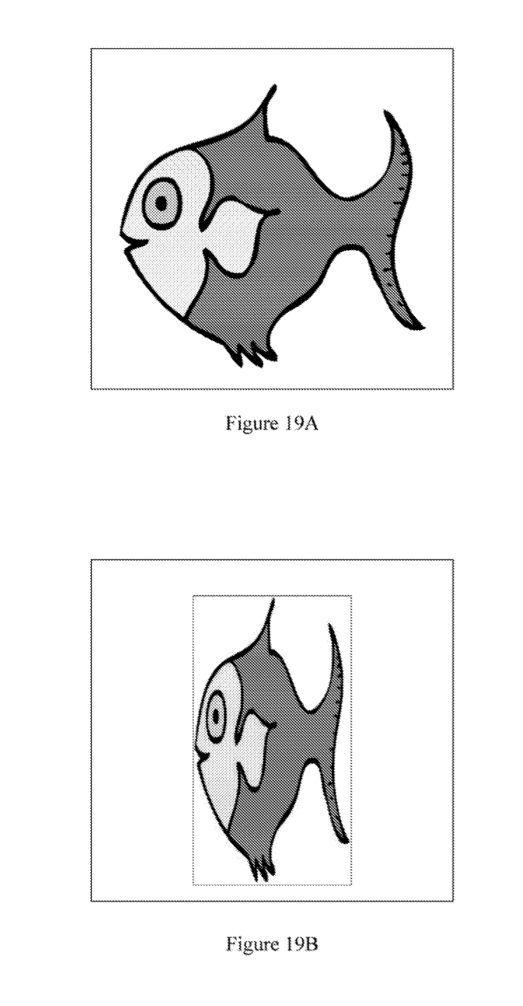

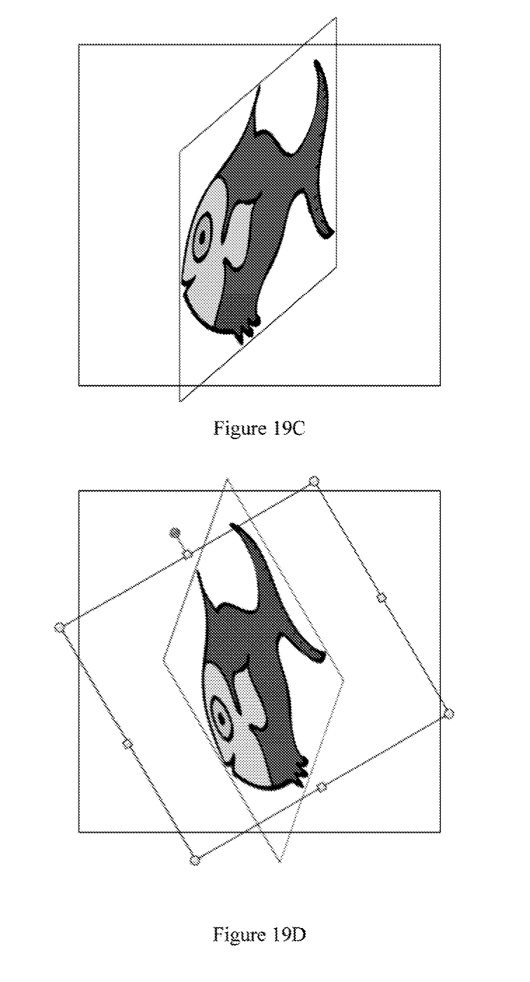

A preferred embodiment of manipulating 2-D images as 3-D objects is now described. Given any 2-D picture, a 3-D coordinate system may be established with origin at the center of operation, x/y aisles plenary, and z-axis perpendicular to display. FIG. 19A shows a fish swimming from right to left. The same application independent pinch operation used in picture zooming described above may be employed as application dependent 3-D rotation operation here. In a 3-D application state, the pinch operation now has the following different semantics:

Along x-axis (left-right):
Pinch towards center: defined as pushing x-axis into paper.
Pinch away from center: defined as pulling x-axis out of paper.

Along y-axis (up-down):
Pinch towards center: defined as pushing y-axis into paper.
Pinch away from center: defined as pulling y-axis out of paper.

Along any other eccentric direction:
Combine x/y. p Along any encircle direction:
Rotate z-axis.

FIG. 19B shows the result of pinching with thumb of right hand as center of operation holding the center of the fish and index finger moving from right to left, effectively pushing the tail of the fish inwards (towards paper) for 60 degrees and hence pulling the fish head outwards for the same 60 degrees. Visually if the same is interpreted as 2-D operation, it is one-dimension zooming without maintaining aspect ratio.

FIG. 19C is visually more apparent as 3-D operation. It is the result of rotating what in FIG. 19A in x-direction by 60 degrees and y-direction by 330 degrees (or −30 degrees).

FIG. 19D shows the result of rotating what in FIG. 19A in x-direction by 60 degrees, in y-direction by 330 degrees (or −30 degrees), and z-direction by 30 degree.

In the foregoing detailed description, a method, an apparatus, and a computer program for operating a multi-object touch handheld device with touch sensitive display have been disclosed. The important benefits of the present invention may include but not limited to executing touch operation based on center of operation on multi-object touch handheld device with touch sensitive display, improving the usability of previously complex 2-D touch operations with multi-object touch, and enabling powerful 3-D touch operations with multi-object touch on touch sensitive display.

While embodiments and applications of this invention have been shown and described, it would be apparent to those skilled in the art that many more modifications and changes than mentioned above are possible without departing from the spirit and scope of the invention. This invention, therefore, is not to be restricted.

1. A method of performing touch operation on a graphical object on a touch sensitive display of a multi-object touch handheld device, comprising:
detecting the presence of at least two touch input objects;
determining one of the said touch input objects as pointing at a center of operation;
determining a type of operation;
performing the said type of operation on the said graphical object at the said center of operation.

2. A method of claim 1, wherein at least one of the said touch input objects is a human finger.

3. A method of claim 1, wherein the said center of operation is a point of interest.

4. A method of claim 1, wherein the said center of operation is determined at least partially by area of touch of the said touch input objects.

5. A method of claim 1, wherein the said center of operation is determined at least partially by motion of touch of the said touch input objects.

6. A method of claim 5, wherein the said motion of touch is at least partially derived from measuring velocity of the said touch input object.

7. A method of claim 5, wherein the said motion of touch is at least partially derived from measuring acceleration of the said touch input object.

8. A method of claim 1, wherein the said center of operation is determined at least partially by order of touch of the said touch input objects.

9. A method of claim 8, wherein the said order of touch is at least partially derived from measuring time of touch of the said touch input objects.

10. A method of claim 8, wherein the said order of touch is at least partially derived from measuring proximity of the said touch input objects.

11. A method of claim 1, wherein the said center of operation is determined at least partially by position of touch of the said touch input objects.

12. A method of claim 1, wherein the said center of operation is determined at least partially by number of touch of the said touch input objects.

13. A method of claim 1, wherein the said type of operation is determined at least partially by computing type of physical actions of the said touch input objects.

14. A method of claim 13, wherein the said type of physical action is tapping by at least one of the said touch input objects touching and immediately leaving the said touch sensitive display without notable lateral movement.

15. A method of claim 13, wherein the said type of physical action is ticking by at least one of the said touch input objects touching and immediately leaving the said touch sensitive display with notable movement towards a direction.

16. A method of claim 13, wherein the said type of physical action is flicking by at least one of the said touch input objects touching and moving on the said touch sensitive display for a notable time duration or a notable distance and then swiftly leaving the surface with notable movement towards a direction.

17. A method of claim 13, wherein the said type of physical action is pinching by at least two of the said touch input objects touching the said touch sensitive display and one of the at least two touch input objects moving principally along the direction of it towards or away from another of the at least two touch input objects.

18. A method of claim 13, wherein the said type of physical action is press-holding by at least one of the said touch input objects touching and staying on the said touch sensitive display for a notable amount of time without significant lateral movement.

19. A method of claim 13, wherein the said type of physical action is blocking by at least two of the said touch input objects first touching the said touch sensitive display and then lifting at roughly the same time.

20. A method of claim 13, wherein the said type of physical action is encircling by at least one of the said touch input objects moving encircle around one of the other the said touch input objects.

21. A method of claim 1, further comprises:
determining current application state;
retrieving the set of types of operations allowed for the said current application state.

22. A method of claim 1, wherein the said type of operation is zooming, comprising changing the size of at least one graphic object shown on the said touch sensitive display and sticking the said at least one graphic object at the said center of operation.

23. A method of claim 1, wherein the said type of operation is rotation, comprising changing the orientation of at least one graphic object shown on the said touch sensitive display and sticking the said at least one graphic object at the said center of operation.

24. A method of claim 23, wherein the said rotation type of operation is coupled with encircle type of physical action; comprising:
at least one of the said touch input objects moving encircle around one of the other the said touch input objects;
the motion of touch is in deceleration before lifting the moving touch input object.

25. A method of claim 23, wherein the said rotation type of operation is coupled with encircle type of physical action; comprising:
at least one of the said touch input objects moving encircle around one of the other the said touch input objects;
the motion of touch is in acceleration before lifting the moving touch input object;
at least one graphical object orientation is turned by 90 degree.

26. A method of claim 1, wherein the said type of operation is 3D rotation, comprising changing the orientation of at least one graphic object shown on the said touch sensitive display in spatial 3D space and sticking the said at least one graphic object at the said center of operation.

27. A method of claim 26, wherein the said 3D rotation type of operation is coupled with pinch and encircle type of physical action; comprising:
at least two of the said touch input objects touching the said touch sensitive display and one of the at least two touch input objects moving principally along the direction of it towards or away from another of the at least two touch input objects;
at least one of the said touch input objects moving encircle around one of the other the said touch input objects;
the motion of touch is in deceleration before lifting.

28. A method of claim 26, wherein the said 3D rotation type of operation is coupled with pinch and encircle type of physical action; comprising:
at least two of the said touch input objects touching the said touch sensitive display and one of the at least two touch input objects moving principally along the direction of it towards or away from another of the at least two touch input objects;
at least one of the said touch input objects moving encircle around one of the other the said touch input objects;
the motion of touch is in acceleration before lifting;
at least one graphical object orientation is turned by 90 degree.

29. A handheld device with at least one processor and at least one type of memory, further comprising:
touch sensitive display capable of showing at least one graphical object and sensing input from at least two touch input objects;
means for determining the presence of the said touch input objects touching the said touch sensitive display;
means for determining a center of operation.

30. A handheld device of claim 29, wherein the said touch sensitive display senses touch input objects by measuring at least one of the following physical characteristics: capacitance, inductance, resistance, acoustic impedance, optics, force, or time.

31. A handheld device of claim 29, wherein the said means for determining the said center of operation comprises at least one of the following means:
a. means for measuring area of touch;
b. means for measuring order of touch;
c. means for measuring motion of touch;
d. means for measuring position of touch;
e. means for measuring time of touch;
f. means for measuring proximity of touch;
g. means for measuring number of touch.

32. A handheld device of claim 29, further comprises at least one of the following means for determining type of operation:
a. means for storing and retrieving the definition of at least one type of operations;
b. means for comparing said sensing input from said touch input objects with the said definition of at least one type of operations.

33. A handheld device of claim 29, further comprises means for recording and retrieving application states.

34. A handheld device of claim 29, further comprises means for sticking at least one graphical object at the said center of operation for executing said type of operations.

35. A handheld device of claim 29, further comprises means for changing said at least one graphical object on the said touch sensitive display.
